(19) United States
(12) Patent Application Publication
(10) Pub. No.: US 2005/0016660 A1
(43) Pub. Date: Jan. 27, 2005

(54) Method and device for producing a multi-part plastic product

(76) Inventor: Richard Herbst, Tegernsee (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/492,121

(22) PCT Filed: Oct. 18, 2002
(86) PCT No.: PCT/EP02/11709

(30) Foreign Application Priority Data
Oct. 19, 2001 (DE) 101 52 816.7

(51) Int. Cl. B32B 31/00

(52) U.S. Cl. 156/85; 156/322; 156/381

(57) ABSTRACT

The present invention relates to a method and a device for producing a multi-part plastic product. The device possesses first means for the provision of a first plastic part, second means (for the production of a second plastic part and third means for the connection of the two plastic parts. The device according to the invention is characterized in that the third means contain a heating unit for heating the first plastic part to a defined temperature, and in that the heating unit has an actuating element, by means of which the defined temperature can be set in such a way that a thermal shrinkage of the first plastic part during cooling is equal to an ageing shrinkage of the second plastic part.

The present invention relates to a method for producing a multi-part plastic product, with the steps:
provision of a first plastic part
provision of a second plastic part, and
connection of the first and of the second plastic part to one another to form the plastic product, the connection step taking place in time after the production of the second plastic part.

The invention relates, furthermore, to a device for carrying out such a method, with first means for the provision of a first plastic part, with second means for the production of a second plastic part and with third means for the connection of the two plastic parts.

Such a method and a corresponding device are known in terms of their use.

An actual example of the known method and of the corresponding device is the production and subsequent packaging of CD boxes or DVD boxes. The boxes are first produced by an injection-moulding method, and they form the second plastic part within the meaning of the more general description mentioned in the introduction. The first plastic part within the meaning of this description is a plastic film with which the CD/DVD boxes are packaged after production and after the insertion of the CD/DVD. The boxes are wrapped in the plastic film and the film is subsequently heat-sealed. The finished plastic product within the meaning of the description mentioned in the introduction is therefore the CD or DVD box heat-sealed in the plastic film.

Hitherto, after being extracted from the injection-moulding die, the CD/DVD boxes have been cooled and then stored for a period of time of about 12 hours or more, before further processing, in particular packaging with the plastic film, takes place. An essential reason for this is that, in the first hours after the injection-moulding operation, the CD/DVD boxes run through a shrinkage process, in which the outer dimensions are reduced. The cause of this shrinkage process, which is also designated in the specialized terminology as ageing shrinkage, is that the plastic molecules in a freshly injection-moulded plastic part are oriented permanently with one another only after a period of time. Where injection mouldings are concerned, this process takes place asymptotically and extends over about 24 hours. The particular feature of ageing shrinkage is that, in each plastic part, it occurs only immediately after production and therefore only once.

If the CD/DVD box is heat-sealed in with an exact fit by means of the plastic film within the first hours after extraction from the injection-moulding die, creases are formed later in the film due to the ageing shrinkage of the box. It will be desirable to avoid this, not least for aesthetic reasons. Hitherto, for this purpose, the CD/DVD boxes, after being extracted from the injection-moulding die, have been stored until the ageing shrinkage is concluded to the extent that creasing no longer occurs.

The known measure has the disadvantage, however, that the production process has to be interrupted before final packaging for the consumer can be carried out. The interruption, in turn, prolongs the entire production or processing process and causes additional outlay in terms of the optimization of the production sequences.

One object of the present invention, therefore, is to specify a method and a device of the type mentioned in the introduction, by means of which the adverse consequences of ageing shrinkage, that is to say, in particular, creasing, during the heat-sealing of freshly produced plastic parts in film, can be avoided, without the entire production and processing cycle being interrupted.

This object is achieved by means of a method of the type mentioned in the introduction, in which
the first plastic part is heated, for the connection step, to a defined temperature at which the first plastic part expands by thermal means, and in which
the defined temperature is dimensioned such that a thermal shrinkage of the first plastic part during cooling is equal to an ageing shrinkage of the second plastic part.

The object is achieved, furthermore, by means of a device of the type mentioned in the introduction, in which the third means contain a heating unit for heating the first plastic part to a defined temperature, the heating unit having an actuating element, by means of which the defined temperature can be set in such a way that a thermal shrinkage of the first plastic part during cooling is equal to an ageing shrinkage of the second plastic part.

The invention is therefore based on the essential notion of compensating the change in size of the second plastic part as a result of ageing shrinkage by means of an artificially generated thermal shrinkage in the first plastic part. As is known, the outer dimensions of plastic parts change as a function of the temperature, the plastic part expanding at higher temperatures and contracting at decreasing temperatures. This process is reversible within certain limits and can be repeated as often as desired.

As a result of the heating of the first plastic part, the latter expands, and it therefore possesses, in the step of connection to the second plastic part, increased dimensions which are reduced again during subsequent cooling. Simultaneously with this thermal shrinkage, the dimensions of the second plastic part also decrease as a result of the ageing shrinkage which still persists there. Since the two shrinkage processes are matched to one another by the defined temperature being set according to the invention, the two plastic parts can easily be connected to form the plastic product. Even after the end of the shrinkage processes, the size ratio of the two plastic parts to one another is at least largely maintained.

In the application mentioned in the introduction and also preferred for the present invention, to be precise that in which CD/DVD boxes are heat-sealed in plastic film after injection-moulding, creasing can thereby be avoided, without the production operation being interrupted. As a result, overall, a more efficient and faster production sequence is possible.

However, the invention is not restricted solely to the heat-sealing of injection-moulded CD/DVD boxes, but may be applied generally to all production methods and all plastic parts in which one of the two plastic parts has already concluded its ageing shrinkage, while the second is still passing through the ageing shrinkage process. The invention can therefore, in general, be applied advantageously even when two identical plastic parts from different production operations are to be assembled with an exact fit. Examples are the production of children's toys, accessories for the motor vehicle industry or the production of multi-part disposable articles made of plastic.

In one refinement of the invention, the connection step is carried out in the course of a continuous handling of the second plastic part. In the device according to the invention, correspondingly, the first, second and third means are connected to form a production line with continuous handling of the second plastic part.

In this refinement, the advantages of the invention become particularly evident, since the ageing shrinkage becomes noticeable, above all, during the first hours after the production of the second plastic part. In continuous handling of the second plastic part, commencing with production, further processing takes place precisely during this time. The invention, however, may, in principle, also be applied to production processes in which the second plastic parts, after being produced, are first stored intermediately, before they are delivered for further processing.

In a further refinement, after the production step, the second plastic part is first cooled, specifically preferably to room temperature. In the device according to the invention, correspondingly, a cooling station for cooling the second plastic part is arranged between the second and third means.

This measure has the advantage that additional thermal shrinkage in a second plastic part is eliminated, so that the thermal shrinkage of the first plastic part can beutilized completely for compensating the ageing shrinkage. This makes it possible to have a relatively low heating of the first plastic part, thus, on the one hand, saving energy and, on the other hand, further optimizing the production operation. Moreover, in this refinement, only two shrinkage processes have to be matched to one another, without a third shrinkage process being superposed. This makes it possible to adapt the processes to one another more simply and more accurately.

In a further refinement of the abovementioned measure, the connection step is carried out in time immediately after the cooling of the second plastic part.

This measure allows a further optimization of the entire production process, the advantages of the invention becoming particularly evident.

In a further refinement of the invention, the defined temperature is set empirically.

In an application to DVD boxes, it was shown, for example, that the ageing shrinkage of the DVD box amounts to about 50 percent of the thermal shrinkage when the DVD box is extracted at about 60° C. from the die after the injection-moulding operation and is subsequently cooled to room temperature (20° C.). It was shown that a good compensation of the ageing shrinkage is achieved when the plastic film, into which the DVD box is heat-sealed, is previously heated to about 40° C. In the case of a somewhat linear coefficient of expansion during thermal shrinkage, the change in size occurring during cooling corresponds largely to the ageing shrinkage of the DVD box. It goes without saying, however, that the parameters may vary if other plastic parts (other materials, other size ratios) are to be connected to one another to form the plastic product.

The empirical determination of the defined temperature is possible in a very simple and uncomplicated way. It consequently makes it possible to implement the invention particularly cost-effectively and with sufficiently good results. Furthermore, in the case of generic production processes, some test runs are, as a rule, carried out in any case, so that an empirical determination of the defined temperature is possible even without an appreciable additional outlay.

In a further refinement, the first plastic part is provided from a spatially separate stock.

This measure has the advantage that, by virtue of the separate storage and the resulting transport distances, the first plastic part has already concluded its own ageing shrinkage completely, so that no further influencing parameter has to be taken into account in the compensation of the size changes. The method according to the invention can therefore be carried out in an even simpler and more controlled manner. Moreover, the production process can be implemented more flexibly, since it is independent of the production time of the first plastic part.

In a further refinement, a stock of first plastic parts is heated to the defined temperature before the connection step.

By means of this measure, a highly controlled and continuous process sequence is possible, in which the cycle times are largely minimized. By virtue of the said measure, the first plastic part is available, heated, in sufficient quantity, in order to carry out the further handling of the second plastic part without delays. At the same time, abrupt temperature changes of the first plastic part are avoided, thus ensuring a high degree of material care and making it possible to have a very exact setting of the temperature. Moreover, the first plastic parts can thereby be heated in a particularly efficient and energy-saving manner.

In a further refinement, the heating step and the connection step are carried out in a thermally insulated chamber.

This measure makes it possible to carry out the method according to the invention particularly accurately under controlled conditions. Moreover, the heating step can thereby be carried out at a low outlay in energy terms. This applies particularly in combination with the abovementioned measure, that is to say, in each case, when a stock of first plastic parts is heated to the defined temperature.

In a further refinement, the second plastic part is introduced into the thermally closed chamber only immediately before connection.

This measure largely prevents an additional and in this case undesirable thermal expansion of the second plastic part. The compensation of the size changes can therefore be carried out in an even more accurate and controlled manner.

In a further refinement of the invention, the first plastic part is a plastic film and the connection step involves a wrapping of the second plastic part with the plastic film.

In this refinement, the advantages of the invention become particularly evident, since, above all, the wrapping of a plastic part with a film leads to the problems described above.

In a further refinement, the production step involves an injection-moulding of the second plastic part. Preferably, in this case, the second plastic part is a CD or DVD box.

In these refinements, too, the advantages of the invention have a particularly marked effect. To be precise, an application is in question here in which the product quality requirements and, in particular, the avoidance of creasing are particularly pronounced.

On the other hand, these are mass-produced products, so that any improvement in the production operation has a particularly great effect.

It goes without saying that the features mentioned above and those yet to be explained below can be used not only in the combination specified in each case, but also in other combinations or alone, without departing from the scope of the present invention.

Exemplary embodiments of the invention are illustrated in the drawing and are explained in more detail in the following description. In the drawing:

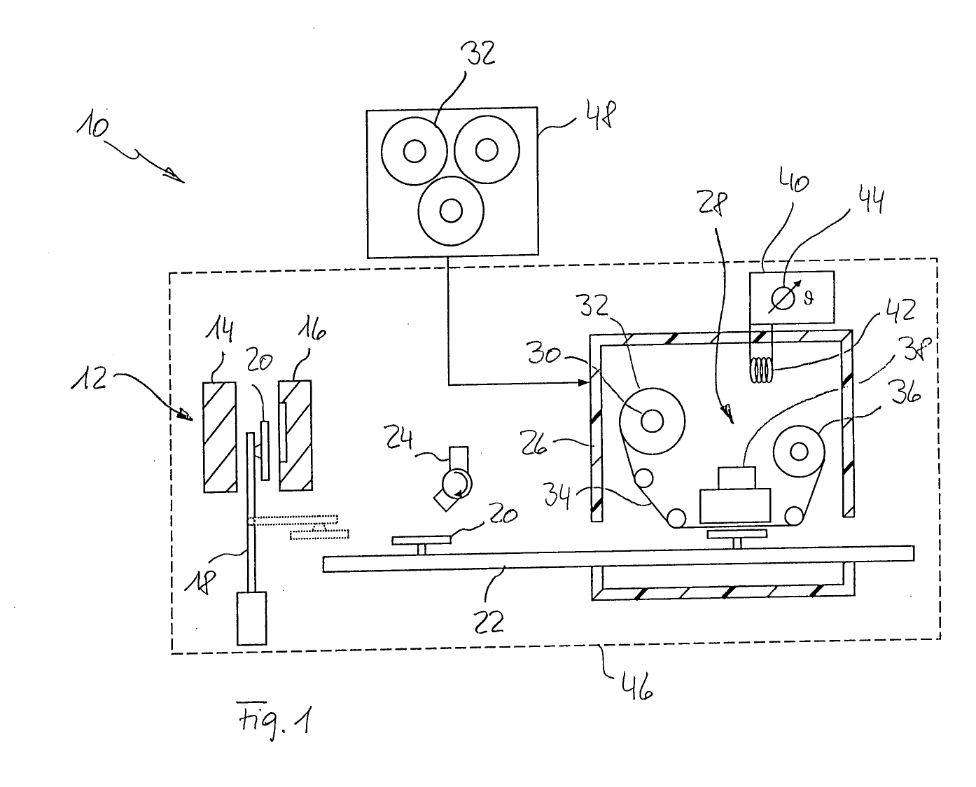

FIG. 1 shows a diagrammatic illustration of a device according to the invention for carrying out the method according to the invention, and

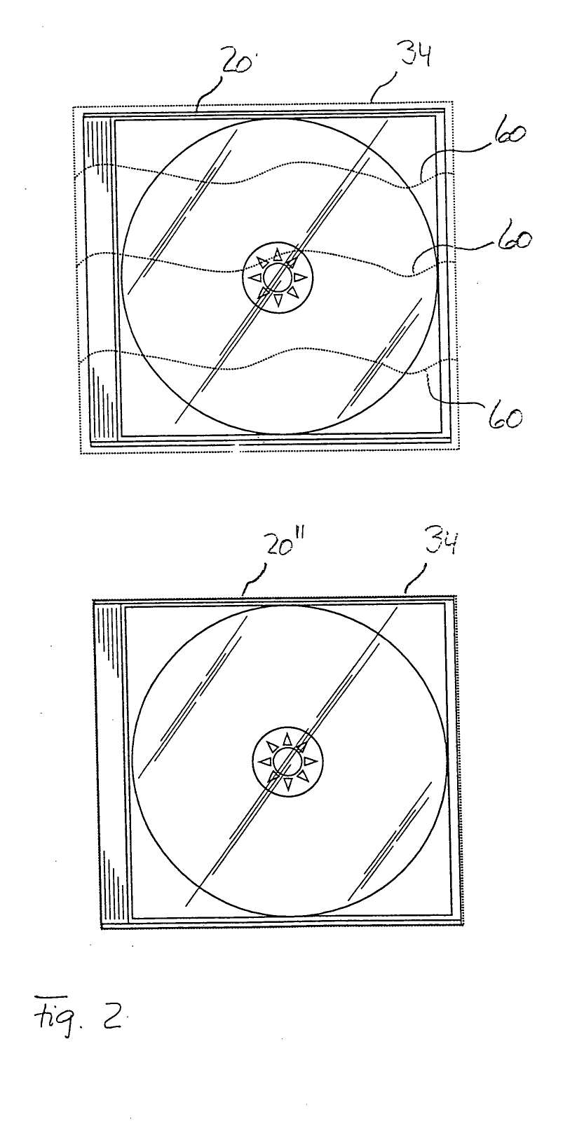

FIG. 2 shows two CD boxes which are heat-sealed in a plastic film.

In FIG. 1, a device according to the invention is designated as a whole by the reference numeral 10.

The device 10 contains an injection-moulding machine 12, known per se, of which only two die halves 14 and 16 are illustrated diagrammatically here. The injection-moulding machine 12 may be designed differently as a function of the plastic parts to be produced and may, for example, also contain multi-tiered dies which are known per se.

The injection-moulding machine 12 is coupled in a known way to a handling appliance 18 which serves for extracting the injection-moulded plastic parts 20 from the mould cavity of the die half 16. According to the preferred application of the invention, the plastic parts produced are, here, CD or DVD boxes.

The handling appliance 18 subsequently transfers the extracted CD/DVD box to a second handling appliance 22. This operation is indicated in FIG. 1 by the working position, depicted by dots, of the handling appliance 18. In this case, the separately illustrated arrangement of the handling appliances 18 and 22 is to be understood merely as an example. In other exemplary embodiments of the invention, the handling appliances 18 and 22 may also be various stages of a comprehensive handling appliance.

The reference numeral 24 designates a blower, by means of which the extracted CD/DVD boxes are cooled to room temperature after being removed from the injection-moulding machine 12.

The cooled boxes are subsequently transported into a chamber 26 by the handling appliance 22. Arranged in the chamber 26 is a unit 28 which heat-seals the boxes 20 in a plastic film. In practice, in this case, further processing steps, such as, for example, the insertion of separately produced CDs into the boxes, may take place between the cooling of the boxes 20 and heat-sealing in the chamber 26.

The unit 28 contains a receptacle 30 for receiving a film reel 32, on which the plastic film 34 processed below is wound. The film 34 is supplied, via guide rollers not identified in any more detail here, to a running roller 36 which receives unrequired residues of the film 34 after the heat-sealing of the CD boxes. The actual heat-sealing apparatus is designated here by the reference numeral 38. The operation of wrapping and heat-sealing CD boxes 20 in plastic film 34 is known per se and is therefore not explained in any more detail here.

The reference numeral 40 designates a heating unit which heats the interior of the thermally insulated chamber 26 via a heating element 42. The desired temperature 4 within the chamber 26 can be set via an actuating element 44.

According to a preferred exemplary embodiment of the invention, the elements described hitherto, that is to say, in particular, the injection-moulding machine 12, the handling appliances 18 and 22, the chamber 26 and also the unit 28 and the heating unit 40, are combined to form a continuous production line 46. The production line 46 allows a continuous handling of the CD/DVD boxes 20 from the first production operation to the provision of the ready-packaged CD/DVD boxes prepared for the consumer.

A stock 48, in which further film reels 32 with plastic film 34 are mounted, is not connected directly to the production line 46. The film reels 32 are supplied to the unit 28, as required, from the separate stock 48.

In the method according to the invention, in the device 10, the CD boxes 20 are first injection-moulded in a way known per se and are cooled to room temperature. Further processing steps then take place, until the CD boxes are finally transported into the chamber 26. They are delivered there to the heat-sealing apparatus 38 which surrounds the CD boxes 20 with the plastic film 34 and heat-seals them. In this case, according to the invention, the plastic film 34 is heated to the defined temperature via the heating unit 40, the temperature being dimensioned empirically such that the thermal shrinkage of the heated film 34 corresponds at least approximately to the ageing shrinkage of the freshly produced CD boxes 20.

Two CD boxes, which in each case are heat-sealed in a plastic film 34, are compared with one another in FIG. 2 in order to illustrate the improvements which can be achieved by means of the invention. In this case, the CD box 20″ illustrated at the bottom in FIG. 2 is produced by the method according to the invention, whilst the CD box 20′ illustrated at the top in FIG. 2 has-been packaged without any compensation of the ageing shrinkage. As indicated in FIG. 2, where the CD box 20′ is concerned, creases 60 are formed in the plastic film 34 some time after packaging, since the outer dimensions of the CD box 20′ have decreased as a result of the ageing shrinkage.

By contrast, as regards the CD box 20″, this size change is compensated by the artificially generated thermal shrinkage of the film 34. The film 34 surrounds the CD box 20″ with an exact fit and without creases.

1. A method for producing a multi-part plastic product, with the steps:
provision of a first plastic part,
production of a second plastic part, and
connection of the first and of the second plastic part to one another to form the plastic product, the connection step taking place in time after the production of the second plastic part, characterized in that the first plastic part is heated, for the connection step, to a defined temperature at which the first plastic part expands by thermal means, and in that the defined temperature is dimensioned such that a thermal shrinkage of the first plastic part during cooling is equal to an ageing shrinkage of the second plastic part.

2. The method according to claim 1, characterized in that the connection step is carried out in the course of a continuous handling of the second plastic part.

3. The method according to claim 1, characterized in that, after the production step, the second plastic part is first cooled, specifically preferably to room temperature.

4. The method according to claim 3, characterized in that the connection step is carried out in time immediately after the cooling of the second plastic part.

5. The method according to claim 1, characterized in that the defined temperature is set empirically.

6. The method according to claim 1, characterized in that the first plastic part is provided from a spatially separate stock.

7. The method according to claim 1, characterized in that a stock of first plastic parts is heated to the defined temperature before the connection step.

8. The method according to claim 1, characterized in that the heating step and the connection step are carried out in a thermally insulated chamber.

9. The method according to claim 8, characterized in that the second plastic part is introduced into the thermally closed chamber only immediately before connection.

10. The method according to claim 1, one characterized in that the first plastic part is a plastic film, and in that the connection step involves a wrapping of the second plastic part with the plastic film.

11. The method according to claim 1, characterized in that the production step involves an injection-moulding of the second plastic part.

12. The method according to claim 1, characterized in that the second plastic part is a CD or DVD box.

13. A device comprising a first means for the provision of a first plastic part a second means for the production of a second plastic part and a third means for the connection of the two plastic parts, characterized in that the third means includes a heating unit for heating the first plastic part to a defined temperature, and in that the heating unit has an actuating element, by means of which the defined temperature can be set in such a way that a thermal shrinkage of the first plastic part during cooling is equal to an ageing shrinkage of the second plastic part.

14. The device according to claim 13, characterized in that the first, the second and the third means are connected to form a production line with a continuous handling of the second plastic part.

15. The device according to claim 13, characterized in that a cooling station for cooling the second plastic part is arranged between the second and the third means.

16. The device according to claim 13, characterized in that the third means contain a thermally closed chamber, in which the heating and connection steps are carried out.

17. The device according to claim 13, characterized in that the first means contain a receptacle for a film reel.

18. The device according to claim 13, characterized in that the second means contain an injection-moulding die.
